(19) United States
(12) Patent Application Publication
(10) Pub. No.: US 2012/0235370 A1
(43) Pub. Date: Sep. 20, 2012

(54) CART CHAIR

(76) Inventors: Jefim Kirshner, Great Neck, NY (US); Jonathan Kirshner, Great Neck, NY (US)

(21) Appl. No.: 13/051,938

(22) Filed: Mar. 18, 2011

(51) Int. Cl. B62B 3/02

(52) U.S. Cl. 280/30

(57) ABSTRACT

A cart chair for moving a load and for sitting on, the cart chair including a body including a first, second, and third pluralities of poles forming parallel top and bottom faces, two parallel side faces perpendicular to the top and bottom faces, and parallel back and front faces perpendicular to the top and bottom and two parallel side faces; a handle including a fourth plurality of poles coupled to the body and extending in the plane of and parallel to the back face; a leg support including a fifth plurality of poles foldably coupled to the handle for supporting the handle when the body is placed on the front face; a back support including a sixth plurality of poles foldably coupled to the body and extending in the plane of and parallel to the bottom face; and a sling for covering the two side, back and front, and the bottom faces.

### FIELD OF THE INVENTION

This invention relates to a cart for transport items and more specifically to a cart that can be used as a chair and a lounge.

### BACKGROUND OF THE INVENTION

These who cannot afford or are not willing to pay the exorbitant rental fees for beach umbrellas and beach chairs so enticingly offered for rent by the ocean front hotels and these who like to enjoy secluded beaches where such staples crucial for beach and picnic enjoyment are not offered for rent, carry their own umbrellas, chairs, blankets, towels, and food in their hand. These items, necessary for beach or picnic enjoyment are commonly carried from home, if in walking distance from the beach, to and from the bus stop, or to and from the car. This chore becomes much more complicated when small children are in tow.

Prior art solutions have largely been directed to affixing oversized wheels to foldable beach chairs and affixing coolers for transporting over sand. This leaves umbrellas, blankets, and lunch baskets to be hand carried. Not to mention that large wheels are difficult to roll over paved surfaces, to and from transportation on the way to the sand line. Such solutions also use hooks and straps that are difficult to manage, especially because the size of the load changes.

Further, commonly sold foldable beach chairs are never as comfortable as the full size beach lounges that are provided by the hotels.

What is needed is a compact, lightweight, easy to handle cart having a capacity sufficient to carry all the necessities for an outing at the beach or a picnic. What is also needed is a chair that as comfortable as the lounges provided for their customers by the beach side hotels.

### SUMMARY OF THE INVENTION

It is an object of the invention to overcome disadvantages in the prior art.

Provided is a cart chair for moving a load and for sitting on, the cart chair including a body including a first, second, and third pluralities of poles forming parallel top and bottom faces, two parallel side faces perpendicular to the top and bottom faces, and parallel back and front faces perpendicular to the top and bottom and two parallel side faces; a handle including a fourth plurality of poles coupled to the body and extending in the plane of and parallel to the back face; a leg support including a fifth plurality of poles foldably coupled to the handle for supporting the handle when the body is placed on the front face; a back support including a sixth plurality of poles foldably coupled to the body and extending in the plane of and parallel to the bottom face; and a sling for covering the two side, back and front, and the bottom faces.

### BRIEF DESCRIPTION OF THE DRAWINGS

The invention is explained in further detail, and by way of example, with reference to the accompanying drawings wherein:

FIG. 1 is a perspective diagram of a cart-chair of the preferred embodiment of the invention;

FIG. 2 is a perspective diagram of the cart-chair of the preferred embodiment of the invention showing a folded handle, side bars, and a back support;

FIG. 3 is a perspective diagram of the cart-chair of FIG. 2 including tilting of the back support;

FIG. 4 is a perspective diagram of the cart-chair of the preferred embodiment of the invention showing an extended handle and leg support;

FIG. 5 is a perspective diagram of the cart-chair of FIG. 2 showing folded handle support;

FIG. 6 is a perspective diagram of the cart-chair of the preferred embodiment of the invention showing the extended handle and folded handle support, side bars, and back support;

FIG. 7 is a perspective diagram of the cart-chair of FIG. 6 showing two unhinged poles for enabling folding of the side faces of the cart-chair;

FIG. 8 is a perspective diagram of the folded cart-chair of the preferred embodiment of the invention; and

FIG. 9 is a perspective diagram of a sling for covering faces of the cart-chair.

### DETAILED DESCRIPTION OF THE INVENTION

The following are descriptions of illustrative embodiments that when taken in conjunction with the drawings will demonstrate features and advantages of the invention. In the following description, for purposes of explanation rather than limitation, illustrative details are set forth. However, it will be apparent to those of ordinary skill in the art that other embodiments that depart from these details would still be understood to be within the scope of the appended claims.

Moreover, for the purpose of clarity, detailed descriptions of well known devices are omitted so as not to obscure the description of the invention. It should be expressly understood that the drawings are included for illustrative purposes and do not represent the scope of the present system. In the accompanying drawings, like reference numbers in different drawings may designate similar elements.

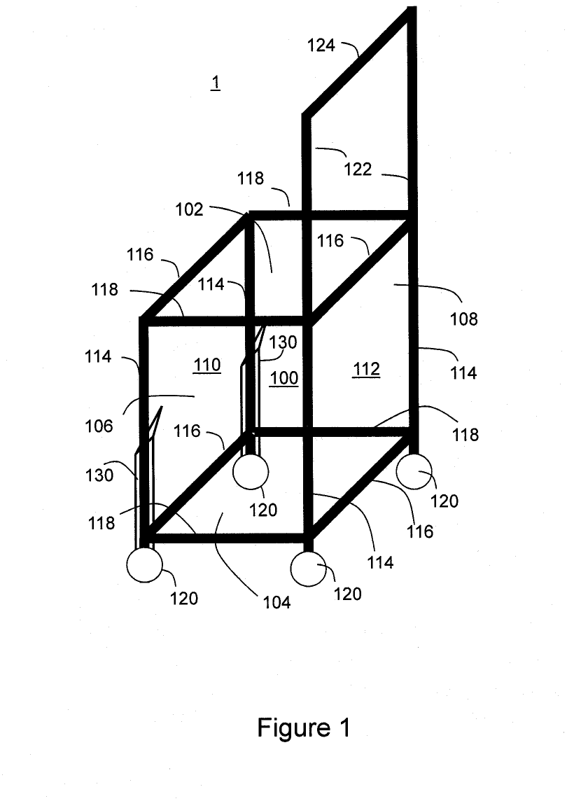

FIG. 1 illustrates a cart-chair 1 of the preferred embodiment of the invention that is similar in form to a personal shopping cart commonly used by shoppers to carry groceries from supermarkets. The cart-chair 1 includes an inner space 100 defined by opposite top and bottom faces 102 and 104, opposite side faces 106 and 108, and opposite front and back faces 110 and 112. The faces are formed by a set of four poles 114, a set of four poles 116 relatively perpendicular to the poles 114 and a set of four poles 118 relatively perpendicular to the poles 114 and 116. Each set having unique length that may differ.

To simplify the description, the faces 102, 104, 106, 108, 110, and 112 are shown in the Figures to be flat or planar. It will be readily understood by these skilled in the art that the poles may be curved and the faces may have different outlines.

The cart-chair 1 includes wheels 120 below the bottom face 104. Optionally there may be four wheels 120, as illustrated or only two below the back face 112. The size of the wheels may vary, however it is preferred that the wheels accommodate rolling of the cart-chair along a firm surface. Additionally, for sliding the cart-chair 1 over sand, tall grass, snow, or like terrain skis 130 are attached below the front face 110. The skis may be permanently or removably affixed and their length may vary with the size of the cart and condition of the sand. Alternatively, wheels commonly used for sand navigation may be used instead the skis. In other words, one pair of wheels 120 is for hard surface and another pair of wheels is for sand and like terrain.

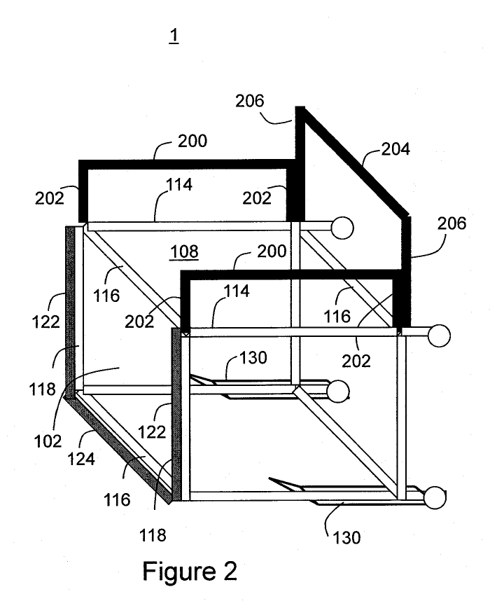

The cart-chair 1 further includes a handle extending away from the top face 102, in the same plane as the back face 112. The handle is formed by two vertical poles 122 connected by a horizontal pole 124. Preferably, a length of the poles 122 does not exceed a length of poles 114 or 118. The poles 122 and 124 may be fixed in a horizontal position, as seen in FIG. 1, or can be attached to the cart-chair 1 with brackets that enable the handle to be folded. The folding may be onto the back face 112 or, as illustrated in FIG. 2, on to the top face 102. Alternatively, by enabling the poles 122 to (or along) into and retract from (or along) the poles 114 on the back face 112 of the cart-chair 1, the handle may be made to retract.

As will be discussed below in more detail, all the faces of the cart-chair 1, except the top face 102, are covered by a strong material that is attached to the poles. This allows placement of items into the space 100. The top face 102 can also be covered, but such covering must be at least partially removable to allow placement of the items into the space 100 of the cart-chair 1. When, as illustrated in FIG. 2, the front face 110 of the cart-chair 1 is placed on the ground, the cart-chair 1 can be used as a chair. The material covering the back face 112 functions as a cushion. It is anticipated that for added comfort, an actual cushion may be attached to the poles forming the back face 112. In the embodiment illustrated in FIG. 2, the handle poles 122, 124 are in the folded position.

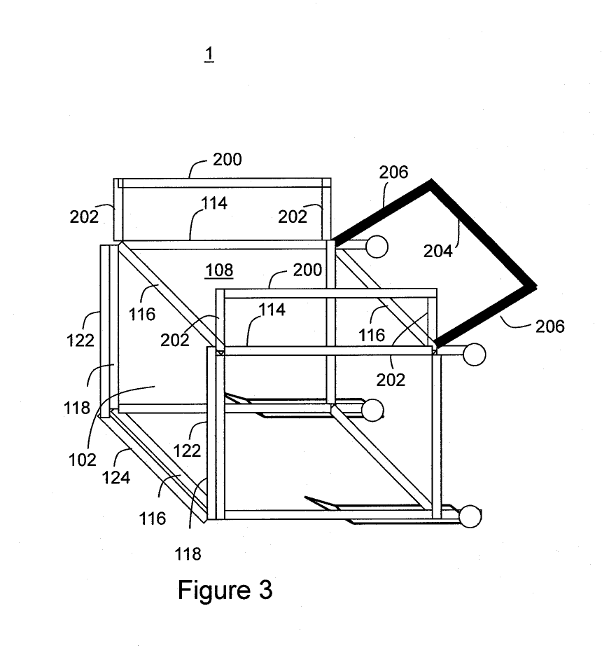

For added sitting comfort, as illustrated, the side bars formed from poles 200 and 202 and a back rest formed by poles 204 and 206 may be optionally added. Similar to the poles 122, poles 202 and 206 may be attached to the cart-chair 1 using brackets that allow movement and affixing in multiple positions and folding. Therefore, the side bars may be folded onto the side faces 106, 108, respectively, or onto the back face 112. Similarly, the back rest may be folded onto the back face 112 or, as illustrated in FIG. 3, positioned in numerous positions suitable for reclining. Also, similar to the handle, the poles 202 and 206 of the side bars and the back rest, may fit into (or along) and retract from (or along) corresponding poles 118 of the cart-chair 1.

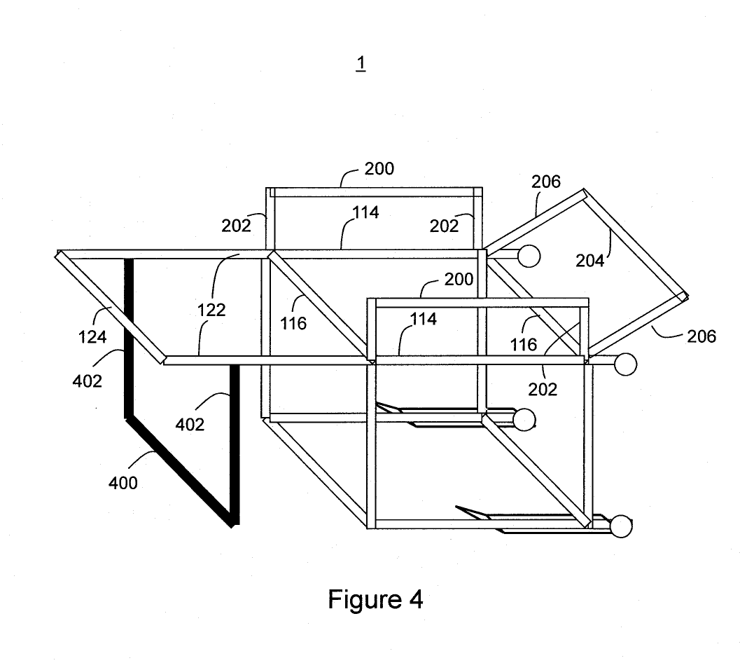

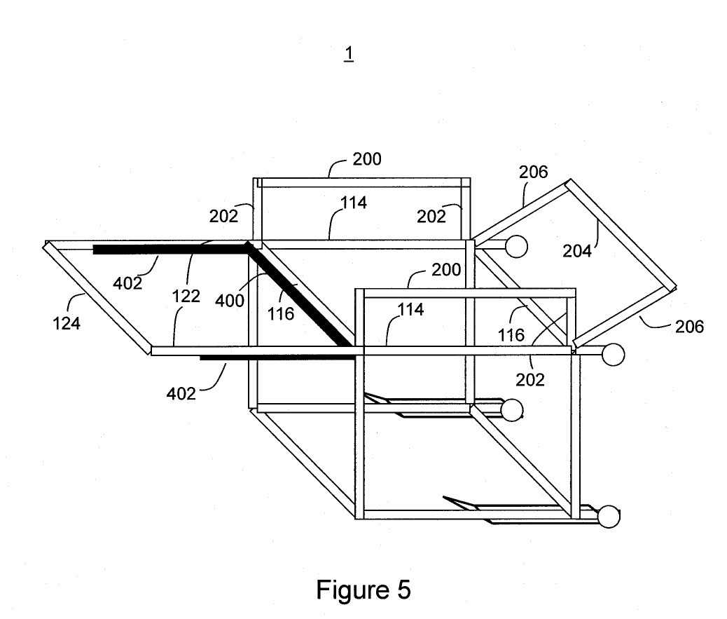

When the poles 122 are in the extended position, as illustrated in FIG. 4, to assure sturdiness of the cart-chair 1, a leg support, formed by poles 400 and 402, is added to support on the ground the poles 122 of the handle, which now functions as a leg rest. This, as is seen from FIG. 4, turns the cart-chair 1 into a lounge chair. As Illustrated in FIG. 5, similar to the poles 122, 202, and 206, the poles 402 of the leg support are foldable.

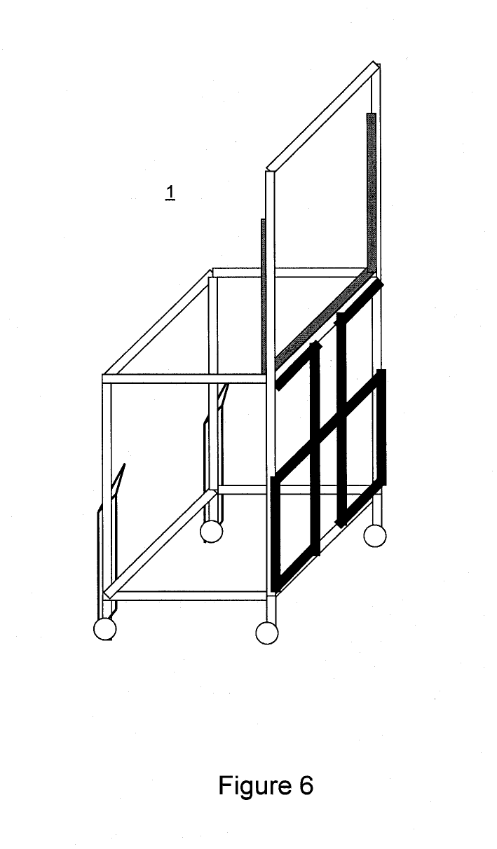

FIG. 6 further illustrates the cart-chair 1 with the side bars, the back rest, and the leg support folded onto the back face 108. In this position, as illustrated, the cart-chair 1 is again, similar to FIG. 1, usable to accept and carry cargo. When at the destination, placement of the cart-chair 1 on the front face 110 and quick unfolding of the hinges connecting the poles 202 and 206 of the side bars and the back rest reveals the chair of FIG. 2. And additional unfolding of the poles 402 of the leg support (and possibly of the poles 122 of the handle) reveals the lounge chair.

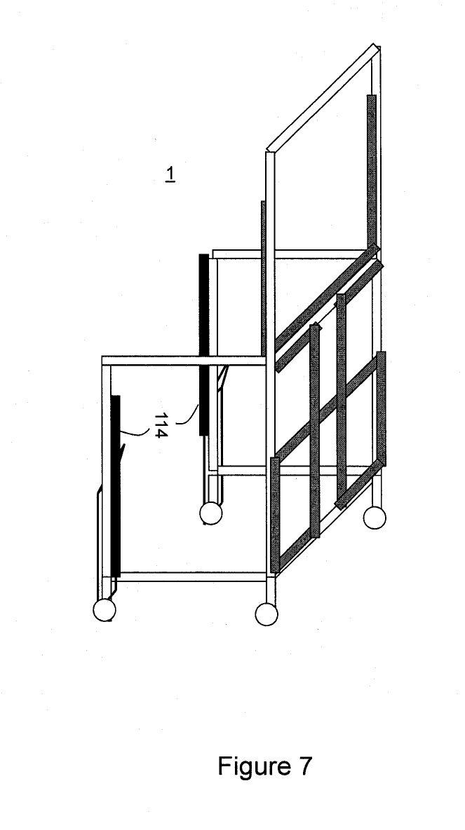

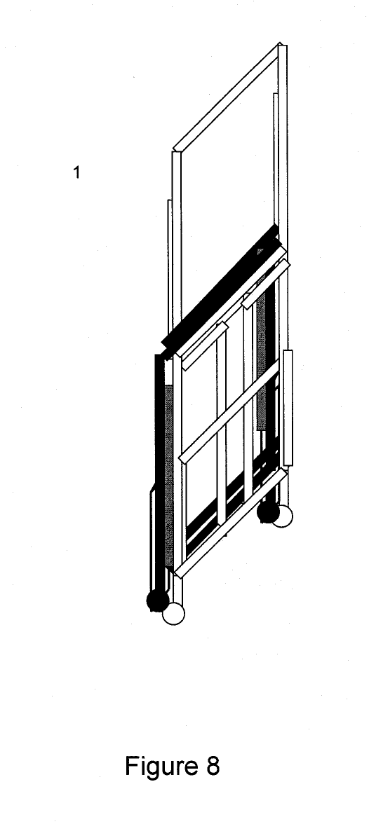

As further illustrated in FIG. 7, the poles 114 on the front face 110 of the cart-chair can be unhinged or uncoupled at one end, e.g., as illustrated, from the opposite poles 116 and folded against the adjoining poles 116. This then, given foldable connection of the poles 118 of the side faces 106 and 108 to the back face 112, allows folding of the opposite side faces 106 and 108 against the back face 112. This, in turn, allows the cart-chair 1 to be folded as illustrated in FIG. 8. Thus folded cart-chair 1 can be easily stowed away in narrow places or a car trunk. It is also noted, as discussed above with reference to FIG. 2, that the poles 122 of the handle can also be folded for further compactness of the folded cart-chair 1.

The poles 114, 116, 118, 122, 124, 200, 202, 204, 206, 400 and 402 can be made of the same or different types of material, for example, PVC or aluminum tubes or piping of various diameters and cross section shapes, or any other kind of material utilized in manufacture of outdoor, patio, or beach furniture. The cross section shapes of the tubes may include circular, oval, triangular, rectangular, star, and other geometrical shapes. The materials for and the manufacture of carts and lounge chairs, including hinges for folding and retracting parts are well known in the art. If piping material is used, various fittings including tees, elbows, caps, etc., can be used to connect the poles.

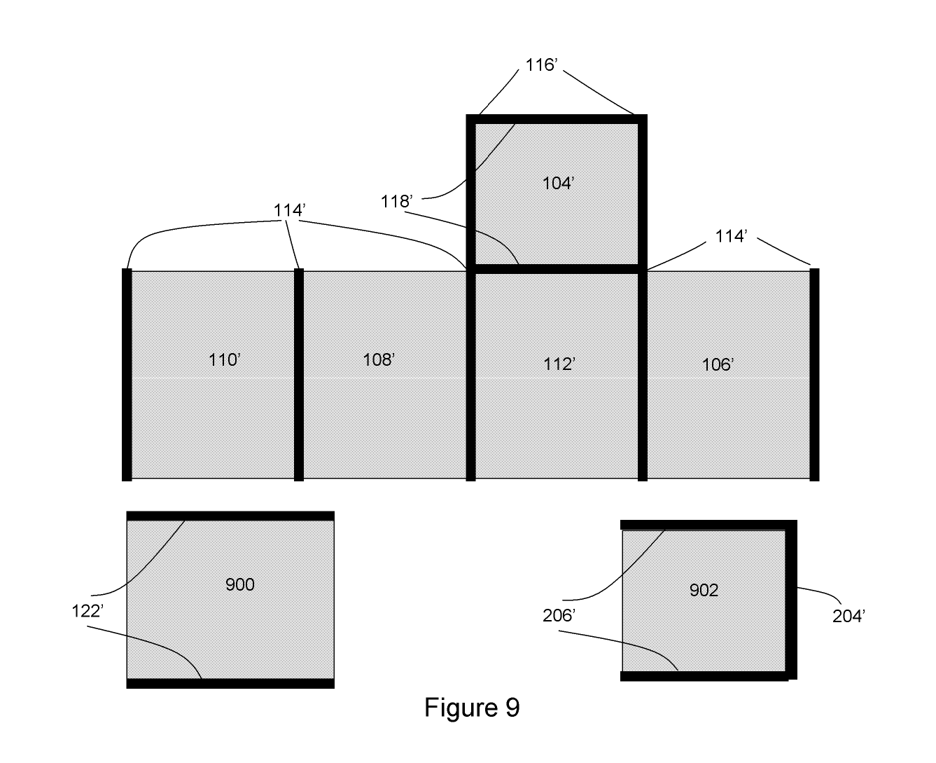

Similarly, manufacture of slings to cover the inner space 100 of the cart-chair 1 to enable the cargo of the cart-chair 1 to be safely transported and to enable comfortable sitting, when the cart-chair 1 is used as the chair or lounge chair, is well known. As illustrated in FIG. 9, a sling of strong and durable material, e.g., UV fabric, is attached to the poles 114 and the poles 116 and 118 of the bottom face of the cart-chair 1. The sling includes pockets 114′ for fitting over or otherwise attaching to the poles 114 and pockets 116′ and 118′ for fitting over or otherwise attaching the poles 116 and 118 of the bottom face 104. Further, the sling includes surfaces 104′, 106′, 108′, 110′, and 112′ for covering corresponding bottom, side, front and back faces 104, 106, 108, 110, and 112 of the cart-chair 1. It is also envisioned that each of the bottom, side, front, and back faces can be covered separately. Only the back face of the cart-chair 1 requires that the covering material be attached such as to support a weight of a user. Other faces may be covered using, for example, Velcro or laces.

Additional slings having surfaces 900 and 902 for the handle and back support and include pockets 122′, 204′ and 206′ for fitting over the corresponding poles 122, 204 and 206. Furthermore, slings (not shown) may be included for the side bars. A cover for the top face may also be added.

Once the sling is in its place, the cart-chair 1 has all the functionality of a commonly used personal shopping cart and that of the chair and lounge chair as discussed above. Accordingly, the cart-chair 1 can be used for either purpose.

Finally, the above discussion is intended to be merely illustrative of the present invention and should not be construed as limiting the appended claims to any particular embodiment or group of embodiments. Thus, while the present invention has been described with reference to exemplary embodiments, it should also be appreciated that numerous modifications and alternative embodiments may be devised by those having ordinary skill in the art without departing from the broader and intended spirit and scope of the present invention as set forth in the claims that follow. The section headings included herein are intended to facilitate a review but are not intended to limit the scope of the present system. Accordingly, the specification and drawings are to be regarded in an illustrative manner and are not intended to limit the scope of the appended claims.

What is claimed is:

1. A cart chair for moving a load and for sitting on, the cart chair comprising:
a body including
a first plurality of poles forming parallel top and bottom faces,
a second plurality of poles forming two parallel side faces perpendicular to the top and bottom faces, and
a third plurality of poles forming parallel back and front faces perpendicular to the top and bottom and the two parallel side faces;
a handle including a fourth plurality of poles coupled to the body and extending in the plane of and parallel to the back face;
a leg support including a fifth plurality of poles movably coupled to the handle for supporting the handle when the body is placed on the front face;
a back support including a sixth plurality of poles movably coupled to the body and extending in the plane of and parallel to the bottom face; and
a sling for covering the two side, back and front, and the bottom faces.

2. The cart chair of claim 1, wherein each of the first, second, and third plurality of poles includes a respective size and cross section.

3. The cart chair of claim 1, further comprising side bars including a seventh plurality of poles coupled to the body and extending in the plane of and parallel to the two side faces.

4. The cart chair of claim 1, further comprising a second sling for covering the handle and a third sling for covering the back support.

5. The cart chair of claim 1, wherein a position of the back support relative the body is adjustable and the back support is foldable onto one of the back and bottom faces.

6. The cart chair of claim 1, wherein a position of the side bars relative the body is adjustable and the side bars are foldable onto the back face.

7. The cart chair of claim 1, wherein the handle is foldable onto one of the top and back faces.

8. The cart chair of claim 7, wherein a position of the leg support relative the handle is adjustable and the leg support is foldable onto the handle.

9. The cart chair of claim 7, wherein the poles of the fourth plurality that connect the handle to the body are slidable into the poles of the back face.

10. The cart chair of claim 1, wherein the two side faces are foldable onto the back face.

11. The cart chair of claim 1, further comprising at least two wheels for moving over firm surfaces and at least devices for moving over sand.

12. A foldable cart chair for moving a load and for sitting on, the cart chair comprising:
two or more top poles and two or more bottom poles positioned in parallel to each other;
two or more first side poles and two or more second side poles positioned in parallel to each other and perpendicular to the top and bottom poles; and
two or more back poles and two or more front poles positioned in parallel to each other and perpendicular to the top, bottom, and the two side poles, all poles are coupled forming a compartment;
a handle including two or more poles coupled to the back poles;
a leg support including two or more poles pivotably coupled to the handle for providing support when the handle is in a horizontal position;
a back support including two or more poles pivotably coupled to one of the back poles and first and second side poles; and
a plurality of slings for covering the space between the bottom, first and second side, back, and front poles.

13. The foldable cart chair of claim 12, wherein the poles of the handle are slidable into the back poles.

14. The foldable cart chair of claim 12, wherein the poles of the back support are slidable into one of the back poles and the first and second side poles.

15. The foldable cart chair of claim 12, wherein the poles of the back support are slidable into one of the back poles and the first and second side poles.

16. The foldable cart chair of claim 12, further comprising one or more sidebars, each including two or more poles coupled to the back poles.

17. The cart chair of claim 12, further comprising at least two wheels for moving over firm surfaces and at least devices for moving over sand.

18. A cart chair for moving a load and for sitting on, the cart chair comprising:
a body including a bottom, sides positioned in parallel to each other and perpendicular to the bottom, and a back and front positioned in parallel to each other and perpendicular to the bottom and the two sides, the bottom, sides, back and front are coupled forming a compartment;
a handle coupled to the body, the handle and back are positioned in the same plane;
a leg support pivotably coupled to the handle for providing support when the handle is in a horizontal position;
a back support coupled to the body opposite the handle, the back support and back are positioned in the same plane,
wherein when the body is positioned placing the back in the horizontal plane, the cart chair is usable as a cart and when the body is positioned placing the back in the horizontal plane atop the front the cart chair is usable as a chair.

19. The cart chair of claim 18, further comprising pair of wheels for moving the body over firm surfaces and a pair items selected from skis and sand wheels for moving over soft sand like surfaces.
